(19) United States
(12) Patent Application Publication
(10) Pub. No.: US 2019/0202189 A1
(43) Pub. Date: Jul. 4, 2019

(54) FIXING METHOD

(71) Applicants: CENTRE TECHNIQUE DE L'INDUSTRIE DES PAPIERS CARTONS ET CELLULOSES, Grenoble Cedex 9 (FR); INSTITUT POLYTECHNIQUE DE GRENOBLE, Grenoble (FR)

(72) Inventors: Julien BRAS, Saint Martin D'Uriage (FR); Didier IMBAULT, Meylan (FR); Barthélémy HARTHONG, Domene (FR); Robert PEYROUX, Saint Ismier (FR); Arnaud REGAZZI, Grenoble (FR); Laura CROWTHER-ALWYN, Grenoble (FR); David GUERIN, Chamalieres (FR); Jérémie VIGUIE, Les Adrets (FR)

(21) Appl. No.: 16/305,929

(22) PCT Filed: Jun. 1, 2017
(86) PCT No.: PCT/FR2017/051379

§ 371 Date: Feb. 8, 2019

(30) Foreign Application Priority Data
Jun. 1, 2016 (FR) 1654975

(51) Int. Cl. B32B 37/06; B65D 65/40; B32B 29/00; B31F 5/06

(52) U.S. Cl. CPC B32B 37/06; B65D 65/40; B65D 65/466; B31F 5/06; B32B 29/005

(57) ABSTRACT

A method for fixing a first surface to a second surface. The method comprises depositing a first layer of nanocellulose on the first surface; bringing the first layer of nanocellulose into contact with the second surface or with a second layer of nanocellulose deposited on the second surface; and fixing the first layer of nanocellulose to the second surface, the second surface containing cellulose, or to the second layer of nanocellulose by a step of ultrasonic welding, which results in a first zone comprising the first layer of nanocellulose, where the first surface is fixed to the second surface, and a second zone around the first zone, where the first surface is not fixed to the second surface.

The present patent application claims the priority of the French patent application FR16/54975 which will be considered as forming an integral part of the present description.

### FIELD

The present application relates to a method for fixing surfaces to one another, in particular surfaces of paper or cardboard objects, and the system obtained by such a method.

### DESCRIPTION OF THE PRIOR ART

Paper and cardboard are products which could be used as packaging with a recycling rate greater than 70% in Europe. However, packaging is generally assembled and heat-sealed or glued using polymers, for example films or polyethylene-based coated compositions, which can make the methods for recycling paper and cardboard complex, and compromise an end of life for both biodegradable or compostable packaging.

It would be desirable to fix surfaces to one another, in particular surfaces of paper or cardboard objects, with products which are easily recyclable, biodegradable and which come from renewable resources.

### SUMMARY

An aim of an embodiment is to overcome all or some of the disadvantages of the methods for fixing surfaces to one another, and the systems thus obtained, described above.

Another aim of an embodiment is that the products used to fix surfaces, are of a natural or biodegradable origin.

Another aim of an embodiment is that the products used to fix surfaces, are easily recyclable.

Another aim of an embodiment is that the fixing method can be implemented on an industrial scale.

Thus, an embodiment provides a system comprising a first surface and a second surface, a first zone where the first surface is fixed to the second surface and a second zone around the first zone where the first surface is not fixed to the second surface, the first zone comprising a first layer of nanocellulose fixed to the first surface, the first layer of nanocellulose being in contact with the second surface and fixed to the second surface, the second surface containing cellulose, or being in contact with a second layer of nanocellulose and fixed to the second layer of nanocellulose, the second layer of nanocellulose being fixed to the second surface.

According to an embodiment, the nanocellulose comprises at least 80% by weight of nanocrystalline cellulose, possibly functionalised on the surface, fibrillated cellulose, possibly functionalised on the surface, or a mixture of nanocrystalline cellulose and fibrillated cellulose, possible functionalised on the surface.

According to an embodiment, the nanocellulose comprises at 80% by weight of nanocrystalline cellulose, possibly functionalised on the surface.

According to an embodiment, the first layer of nanocellulose has a thickness of between 0.5 μm and 20 μm.

According to an embodiment, the first surface belongs to a first object and the second surface belongs to a second object, the first object and/or the second object containing cellulose.

According to an embodiment, at least one of the first object and of the second object is a sheet of paper or a cardboard plate.

Another embodiment provides a method for fixing a first surface to a second surface comprising the following steps:

depositing a first layer of nanocellulose on the first surface;

bringing the first layer of nanocellulose into contact with the second surface or with a second layer of nanocellulose deposited on the second surface; and

fixing the first layer of nanocellulose to the second surface, the second surface containing cellulose, or to the second layer of nanocellulose, which results in a first zone comprising the first layer of nanocellulose where the first surface is fixed to the second surface and a second zone around the first zone where the first surface is not fixed to the second surface.

According to an embodiment, the nanocellulose comprises at least 80% by weight of nanocrystalline cellulose, fibrillated cellulose or a mixture of nanocrystalline cellulose and fibrillated cellulose.

According to an embodiment, the nanocellulose comprises at least 80% by weight of nanocrystalline cellulose.

According to an embodiment, the fixing of the first layer of nanocellulose to the second surface or to the second layer of nanocellulose comprises a step of ultrasonic welding.

According to an embodiment, the first layer of nanocellulose has a thickness of between 0.5 μm and 10 μm.

According to an embodiment, the first surface belongs to a first object and the second surface belongs to a second object, the first object and/or the second object containing cellulose.

According to an embodiment, at least one of the first object and of the second object is a sheet of paper or a cardboard plate.

### BRIEF DESCRIPTION OF THE DRAWINGS

These characteristics and advantages, as well as others, will be described in detail in the following description of specific embodiments, made in a non-limiting manner with respect to the appended figures among which:

FIG. 1 represents, partially and schematically, an embodiment of a system comprising two objects fixed to one another;

FIG. 2 represents, partially and schematically, another embodiment of a system comprising two objects fixed to one another;

FIG. 3 is a block diagram of an embodiment of a method for producing the system represented in FIG. 1;

FIG. 4 illustrates a step of the method illustrated in FIG. 3; and

FIG. 5 illustrates another step of the method illustrated in FIG. 3.

### DETAILED DESCRIPTION

Same elements have been named by same references in the different figures and, in addition, various figures are not drawn to scale. To be clear, only the elements which are useful for the understanding of the embodiments described have been represented and are detailed. Except for any contrary specification, the expressions, “approximately”, “substantially” and “around” mean within 10%, preferably within 5%.

Cellulose is a polymer that is found in a large quantity in biomass, and in particular in the walls of plant cells. It is constituted of glucose chains bound linearly (binding β-1,4) to form macromolecules which are arranged naturally in fibrils. Fibrils are themselves connected to fibres and form the walls of plant fibres.

It is known to form, from natural cellulose, fibrillated cellulose. When fibres have diameters less than 1 μm, fibrillated cellulose is known by the acronym NFC (nanofibrillated cellulose) or by the acronym MFC (microfibrillated cellulose). The fibres contained in fibrillated cellulose typically have a length of between 0.5 and 2 μm and a diameter of between 5 and 70 nm. Fibrillated cellulose is constituted of crystalline regions and amorphous regions. It is noted that, following the description, the term “fibrillated cellulose” is used equally for nanofibrillated cellulose (NFC) or microfibrillated cellulose (MFC).

Cellulose can also be transformed into cellulose crystals, more known by the acronym CNC (crystalline nanocellulose) or NCC (or “whiskers”, or nanocrystalline cellulose). A nanocrystalline cellulose (NCC) is a cellulose crystal of which at least one of the dimensions is less than 100 nm. Nanocrystalline cellulose typically have a length of between 100 nm and 500 nm, for example equal to around 300 nm, and a diameter, most often, of between 5 nm and 20 nm.

Following the description, a material comprising at least 80% by weight of nanocrystalline cellulose possibly functionalised on the surface, fibrillated cellulose (NFC, MFC) possibly functionalised on the surface or a mixture of nanocrystalline cellulose and fibrillated cellulose possibly functionalised on the surface, is called nanocellulose. Preferably, nanocellulose comprises at least 90% by weight of nanocrystalline cellulose. By nanocrystalline or fibrillated cellulose “functionalised on the surface”, this means that the chemical groups are grafted on the surface of the nanocrystalline or fibrillated cellulose.

The inventors have highlighted that fixing two surfaces can be done by using nanocellulose. In particular, the inventors have highlighted that a first layer of nanocellulose deposited on a first surface can be fixed to a second layer of nanocellulose deposited on a second surface, or can be fixed directly to the second surface in the case where the second surface belongs to an object containing cellulose.

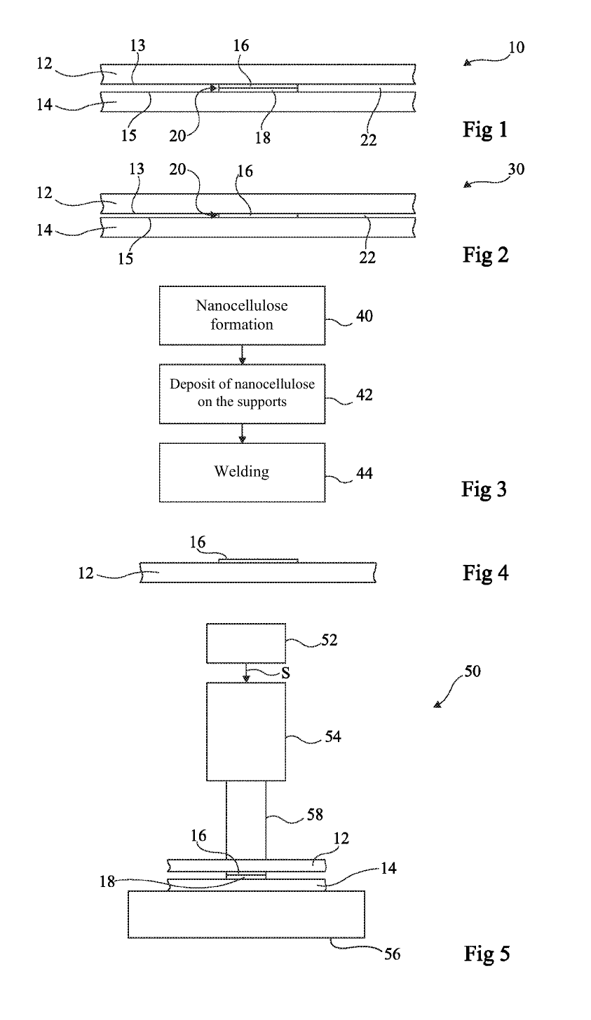

FIG. 1 represents an embodiment of a system 10 comprising a first object 12 comprising a first surface 13 and a second object 14 comprising a second surface 15. According to an embodiment, the first object 12 and the second object 14 are flattened objects, i.e. that they correspond to objects for which the smallest dimension is less, by at least a factor 10, that the other dimensions of the object. According to an embodiment, the first object 12 and/or the second object 14 contain cellulose, preferably at least 50% by weight of cellulose, more preferably at least 80% by weight of cellulose. In a variant, the first object 12 and/or the second object 14 cannot contain cellulose and be any solid material, for example made of plastic material. In this case, a pre-treatment of surface (of corona or plasma type) or an interface layer, not represented, can be provided between each layer of nanocellulose 16, 18 and the associated object 12, 14, in order to facilitate the adhesion of the layer of nanocellulose 16, 18 on the associated object 12, 14.

As an example, the first object 12 is a sheet of paper or a cardboard plate and the second object 14 is a sheet of paper or a cardboard plate. As an example, the thickness of the first object 12 and/or of the second object 14 is between 10 μm and 350 μm. According to an embodiment, the first object 12 and the second object 14 form part of one same object, for example an envelope, a cardboard box, a sealed package, etc.

The system comprises a first layer of nanocellulose 16 on a part of the first surface 13, in contact with the first surface 13 and fixed to the first surface 13 and a second layer of nanocellulose 18 on a part of the second surface 15, in contact with the second surface 15 and fixed to the second surface 15. The first surface 13 and the second surface 15 have complementary shapes at least at the layers of nanocellulose 16, 18. According to an embodiment, the first surface 13 and the second surface 15 are substantially flat at least at the layers of nanocellulose 16, 18. The first layer of nanocellulose 16 is in contact with the second layer of nanocellulose 18 and fixed to the second layer of nanocellulose 18. The first and second layers of nanocellulose 16, 18 can be interpenetrated at least partially. According to an embodiment, the maximum thickness of each layer of nanocellulose 16, 18, measured along a direction perpendicular to the first surface 13 or to the second surface 15, is between 0.5 μm and 20 μm and preferably between 0.5 μm and 10 μm.

The first layer of nanocellulose 16 and the second layer of nanocellulose 18 form a fixing zone 20 between the first object 12 and the second object 14. The dimensions of each layer of nanocellulose 16, 18 depend on the desired dimensions of the fixing zone 20 between the first and second surfaces 13, 15. According to an embodiment, the minimum dimension of the fixing zone 20 in a plane parallel to the first and second surfaces 13, 15 at the fixing zone 20 is greater than 500 μm. As an example, the maximum dimension of the fixing zone 20 in a plane parallel to the first and second surfaces 13, 15 is less than 5 cm. Around the fixing zone 20, the first object 12 is not mechanically connected to the second object 14 and a gap 22, for example filled with air, can be present between the first object 12 and the second object 14.

FIG. 2 represents another embodiment of a system 30 comprising all the elements of the system 10 with the difference that the second layer of nanocellulose 18 is not present. The fixing zone 20 thus corresponds to the interface between the first layer of nanocellulose 16 and the second surface 15. In this embodiment, the second object 14 at least contains cellulose, preferably at least 50% by weight of cellulose, more preferably at least 80% by weight of cellulose.

FIG. 3 is a block diagram of an embodiment of a method for producing the system 10 represented in FIG. 1 comprising successive steps 40, 42 and 44.

In step 40, the method comprises the formation of nanocellulose. Nanocrystalline cellulose (NCC) can be obtained using chemical treatments, for example by hydrolysis of cellulose with a sulphuric acid treatment. Fibrillated cellulose (NFC or MFC) can be obtained by a mechanical treatment step carried out on a mixture of cellulose fibres, for example wood, suspended (pulped). This step is a mechanical disintegration of cellulose fibres, for example by fibre friction, generally done in a homogenisation or friction machine.

Additional treatments can be carried out in step 40 or between steps 40 and 42 to obtain nanocelluloses, functionalised on the surface from nanocellulose. The treatments are, for example, enzymatic or chemical treatments, corresponding for example to esterification, etherification, silanisation, surface polymerisation or urethane formation reactions. As an example, hydroxyl groups (—OH) of cellulose are made to react, partially or totally with different chemical reagents to give cellulose esters or cellulose ethers. To obtain cellulose esters, the reagents can be organic or anhydride acids, for example a fatty chain carboxylic acid. To obtain cellulose ethers, the reagents can be halogenoalkanes, for example fatty chain epoxides.

At the end of step 40, the composition comprising nanocellulose can be in the form of a fluid or viscous suspension, for example in the form of gel. As an example, the composition comprising nanocellulose comprises between 0.1% and 20% by weight of nanocellulose, preferably between 2% and 10%. The solvent is generally water and can be water/alcohol mixtures or any other solvent wherein the nanocellulose suspension, possibly functionalised, is stable, i.e. that it is easily dispersed and makes it possible for a homogenous deposition.

In step 42, the first layer of nanocellulose 16 is formed on the first object 12 and the second layer of nanocellulose 18 is formed on the second object 14. The formation of the layer of nanocellulose 16 can be made by depositing the composition containing nanocellulose on the first object 12 by a method called additive, for example by any surface coating technique, called coating for papers, like for example bar coating or blade coating even curtain coating, but also by direct printing of the composition comprising nanocellulose in the desired places, for example by inkjet printing, heliographic printing, serigraphic printing, flexographic printing, spray coating or drop-casting. A drying step can thus be provided to let the solvent of the deposited composition evaporate. As an example, the composition containing nanocellulose can be deposited with a quantity which could vary from 0.5 g/m² to 10 g/m² and a thickness of between 0.5 μm and 10 μm. The layer of nanocellulose 18 can be formed in the same way as the layer of nanocellulose 16.

FIG. 4 represents a structure example obtained after step 42 wherein the layer of nanocellulose 16 has been formed on the object 12.

Step 44 corresponds to the fixing of the layer of nanocellulose 16 deposited on the object 12 at the layer of nanocellulose 18 deposited on the object 14 in the case of the system 10 or directly on the surface 15 of the object 14 in the case of the system 30.

Step 44 can comprise the bringing into contact of the layer of nanocellulose 16 against the layer of nanocellulose 18 and the at least partial local heating of the layers of nanocellulose 16 and 18 in contact in the case of the system 10 and comprise the bringing into contact of the layer of nanocellulose 16 against the surface 15 and the at least partial local heating of the layer of nanocellulose 16 in the case of the system 30. The heating can be done by an external heat source and/or by mechanical friction of the layers of nanocellulose 16 and 18 against one another in the case of the system 10 and of the layer of nanocellulose 16 and of the object 14 in the case of the system 30. Step 44 can comprise the local compressing of the objects 12 and 14 in the fixing zone, for example at a pressure greater than 0.25 MPa, preferably greater than 0.28 MPa, in particular between 0.5 MPa and 20 MPa.

According to an embodiment, step 44 comprises a step of ultrasonically welding layers of nanocellulose 16, 18 to one another in the case of the system 10 and of the layer of nanocellulose 16 to the object 14 in the case of the system 30. High-frequency vibrations are applied to the two objects 12 and 14 by means of a vibrating tool called a sonotrode or welding head. The welding is done using generated heat and/or mechanically vibrated heat at the interface of the parts to be fixed. The duration of the welding step can be between 0.005 s and 10 s. Preferably, the local maximum temperature in the layer of nanocellulose 16 during step 44 is less than 350° C.

FIG. 5 partially and schematically represents an ultrasonic welding device 50 example. The device 50 comprises:

an electrical generator 52 providing an electrical oscillating control signal S;

an electromagnetic transducer or converter 54 which converts the control signal into a mechanical oscillation movement;

a device for holding 56 the object 12 on which have been deposited parts to be welded, i.e. in the case of the system 10 represents in FIG. 1, the object 12 on which has been deposited the layer of nanocellulose 16 and the object 14 on which has been deposited the layer of nanocellulose 18, the layers of nanocellulose 16 and 18 being in contact with one another and, in the case of the system 30 represented in FIG. 2, the object 12 on which has been deposited the layer of nanocellulose 16 and the object 14, the layer of nanocellulose 16 being in contact with the object 14; and a sonotrode 58 configured to transmit oscillation movements from the converter 54 to the parts to be welded.

The frequencies typically used are between 20 kHz and 70 kHz and the amplitudes of the vibrations vary between 10 μm and 120 μm, according to the type of material and the shape of the parts to be assembled. The duration of the welding operation can be greater than 0.8 s, preferably greater than 0.9 s.

The inventors have carried out peeling tests in the case of the system 10 and of the system 20. The layers of nanocellulose 16 and 18 comprised at least 90% by weight of nanocrystalline cellulose and corresponded to strips having a width of 4 mm (+/−1 mm) and a length of 28 mm (+/−1 mm). The peeling angle was 180°. The maximum peeling load corresponds to the force necessary for separating the two objects 12 and 14 divided by the width of the fixing zone 20. The inventors have obtained peeling forces greater than 0.8 Newtons for widths of 25 mm, while in the absence of layers of nanocellulose, the adhesion between the surfaces was zero. In certain cases, when the peeling load between two paper surfaces was not zero, the maximum load could reach a value twice as high, for example 10 Newtons every 25 mm instead of 5 Newtons every 25 mm.

Tests have been carried out. For these tests, the cardboard used was a cardboard with wood inside or multilayer FBB cardboard (folding box board) of 300 g/m² produced by the company, Stora Enso. For certain tests, this cardboard has been coated on the fibrous face thereof with nanocelluloses. Two types of nanocellulose have been used: nanofibrillated cellulose (NFC) or nanocrystalline cellulose (NCC) suspended in water at respectively 2% and 12% by mass. The coating has been done using the Endupap type coating machine which is an automatic machine making it possible for coating using Meyer bars. The quantity deposited of nanocellulose in one or more passages can vary from 0.5 g/m² to 5 g/m². The drying of the cardboard is then done by contact at 100° C. for 10 minutes. The ultrasonic welding is done using an ultrasonic device commercialised under the name Omega III DG-MCX by the company, Mécasonic. The frequency of the ultrasounds was 20 kHz with an amplitude of ultrasonic waves of 90 μm.

### Example 1

For the first example, the first, second and third pairs of FBB cardboards have been used.

For the first pair of cardboards, there has been no nanocelluloses deposited on the cardboards of the first pair. The cardboards of the first pair have been applied against one another, and an ultrasonic welding operation has been done. No adhesion to one another of the cardboards of the first pair has been observed.

For the second pair of cardboards, there has been no nanocelluloses deposited on one of the cardboards of the second pair and nanocelluloses have been deposited on the other cardboard of the second pair. The cardboards of the second pair have been brought into contact against one another on the side of the layer of nanocelluloses and an ultrasonic welding operation has been done. An adhesion to one another of the cardboards of the second pair has been observed.

For the third pair of cardboards, nanocelluloses have been deposited on each cardboard of the third pair. The cardboards of the third pair have been applied against one another on the side of the layers of nanocelluloses and an ultrasonic welding operation has been done. An adhesion to one another of the cardboards of the third pair has been observed.

The first example highlights that no adhesion between two cardboards has been observed and the absence of nanocelluloses while an adhesion is observed when at least one layer of nanocelluloses is present on one of the cardboards.

### Example 2

For the second example, several pairs of FBB cardboards have been used. For each pair of cardboards, nanocelluloses have been deposited on each cardboard of the pair. The cardboards of each pair have been applied against one another on the side of the layers of nanocelluloses and an ultrasonic welding operation has been done. Two parameters have been modified during ultrasonic welding operations: the welding duration and the pressure applied on the cardboards. Several pressure/duration torques have been tested. Peeling tests at 180° have been carried out when the welding of the cardboards was observed.

Table I groups together the results of the tests. The non-empty boxes of the table indicate the tests carried out. When a welding has not been able to be obtained or quantified during the peeling test, the term “ND” has been added to the table. The listed values (expressed in N/m) are those obtained during peeling tests at 180°.

TABLE I

| | Pressure (MPa) | | | | | | | |
|---|---|---|---|---|---|---|---|---|
| Duration (a) | 0.15 | 0.175 | 0.25 | 0.28 | 0.29 | 0.3 | 0.31 | 0.32 |
| 0.75 | ND | | ND | | | ND | ND | ND |
| 0.9 | | | | ND | 10 | <5 | | |
| 1 | | | | <5 | 90 | 20 | | |
| 1.1 | | | ND | <5 | 35 | | | |
| 1.2 | | | ND | | | | | |
| 1.3 | | | ND | | | | | |
| 1.5 | | | ND | | | | | |
| 2 | ND | ND | | | | | | |

1. A method for fixing a first surface to a second surface comprising the following steps:
depositing of a first layer of nanocellulose on the first surface;
bringing the first layer of nanocellulose into contact with the second surface or with a second layer of nanocellulose deposited on the second surface; and
fixing the first layer of nanocellulose to the second surface, the second surface containing cellulose, or to the second layer of nanocellulose by a step of ultrasonic welding, which results in a first zone comprising the first layer of nanocellulose where the first surface is fixed to the second surface and a second zone around the first zone where the first surface is not fixed to the second surface.

2. The method according to claim 1, wherein the nanocellulose comprises at least 80% by weight of nanocrystalline cellulose, fibrillated cellulose or a mixture of nanocrystalline cellulose and fibrillated cellulose.

3. The method according to claim 2, wherein the nanocellulose comprises at least 80% by weight of nanocrystalline cellulose.

4. The method according to claim 1, wherein the first layer of nanocellulose has a thickness of between 0.5 μm and 20 μm.

5. The method according to claim 4, wherein the first layer of nanocellulose has a thickness of between 0.5 μm and 10 μm.

6. The method according to claim 1, wherein the first surface belongs to a first object and the second surface belongs to a second object, the first object and/or the second object containing cellulose.

7. The method according to claim 6, wherein at least one of the first object and of the second object is a sheet of paper or a cardboard plate.
